(19) United States
(12) Patent Application Publication
(10) Pub. No.: US 2005/0247502 A1
(43) Pub. Date: Nov. 10, 2005

(54) Axle system with steering capability

(76) Inventors: James Ziech, Kalamazoo, MI (US); Michael L. Zebolsky, Marshall, MI (US)

Correspondence Address: MARSHALL & MELHORN, FOUR SEAGATE, EIGHT FLOOR, TOLEDO, OH, 43604, US

(21) Appl. No.: 11/119,575

(22) Filed: May 2, 2005

Related U.S. Application Data
(60) Provisional application No. 60/569,594, filed on May 10, 2004.

(51) Int. Cl. B60K 17/30

(52) U.S. Cl. 180/253; 280/93.512

(57) ABSTRACT

The present invention is an axle system having a steering capability. A series of links connect a knuckle with a vehicle chassis. The axis of the upper links converge to an upper point outboard of the knuckle. The axis of the lower links converge to a lower point outboard of the knuckle. A virtual steer axis of rotation for the knuckle is provided by a line connecting the upper point and the lower point. A steer link having one end connected to a steering mechanism and the other end connected to the knuckle is also provided.

### RELATED APPLICATION

This application is claiming the benefit, under 35 U.S.C. §119(e), of the provisional application filed May 10, 2004 under 35 U.S.C. §111(b), which was granted Ser. No. 60/569,594. The provisional application is hereby incorporated by reference.

### FIELD OF THE INVENTION

The present invention relates to an axle system with steering capability and a method of steering the system.

### BACKGROUND OF THE INVENTION

Prior art systems to steer one or more rear wheels of a vehicle, whether driven or non-driven, are well known. The prior art systems, however, often require additional components that add to the complexity and expense of the steering systems. For example, many of the prior art systems require the use of both a steering knuckle and a steering kingpin. The design of many of the prior art systems also cause them to suffer from poor scrub radii and require significant steering effort, particularly when used with dual wheels or super single tires.

In light of the above disadvantages, it would be advantageous to have a steerable axle system that is less complex and less expensive than know axle systems.

### SUMMARY OF THE INVENTION

The present invention is an axle system for a vehicle having steering capability. The axle system comprises a first upper link, a second upper link, a first lower link and a second lower link. The first upper link defines an axis and has an outboard end rotatably mounted to a knuckle and an inboard end rotatably mounted to a vehicle chassis. The second upper link defines another axis and has an outboard end rotatably mounted to the knuckle and an inboard end rotatably mounted to the vehicle chassis. The first lower link defines another axis and has an outboard end rotatably mounted to the knuckle and an inboard end rotatably mounted to the vehicle chassis. The second lower link defines another axis and has an outboard end rotatably mounted to the knuckle and an inboard end rotatably mounted to the vehicle chassis.

The axle system also comprises a steer link having one end connected to a selectively moveable steer mechanism and the other end is connected to a lower portion of the knuckle.

Preferably, the axis for the first upper link and the axis for the second upper link intersect at an upper point outboard of the knuckle and the axis for the first lower link and the axis for the second lower link intersect at a lower point outboard of the knuckle. A line can be extended through the upper point and the lower point form an axis about which the knuckle rotates.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a front view of the axle system of the present invention;

FIG. 2 is a front, lower perspective view of the present invention;

FIG. 3 is a front, upper view of a portion of the present invention;

FIG. 4 is a perspective view of a component of the present invention;

FIG. 5 is a top perspective view of the present invention;

FIG. 6 is a top, schematic view of an alternative embodiment of the present invention;

FIG. 7 is a front, schematic view of the embodiment depicted in FIG. 6;

FIG. 8 is a top, schematic view of yet another alternative embodiment of the present invention;

FIG. 9 is a front, schematic view of the embodiment depicted in FIG. 8; and

FIG. 10 is a top schematic view of a steer motion of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

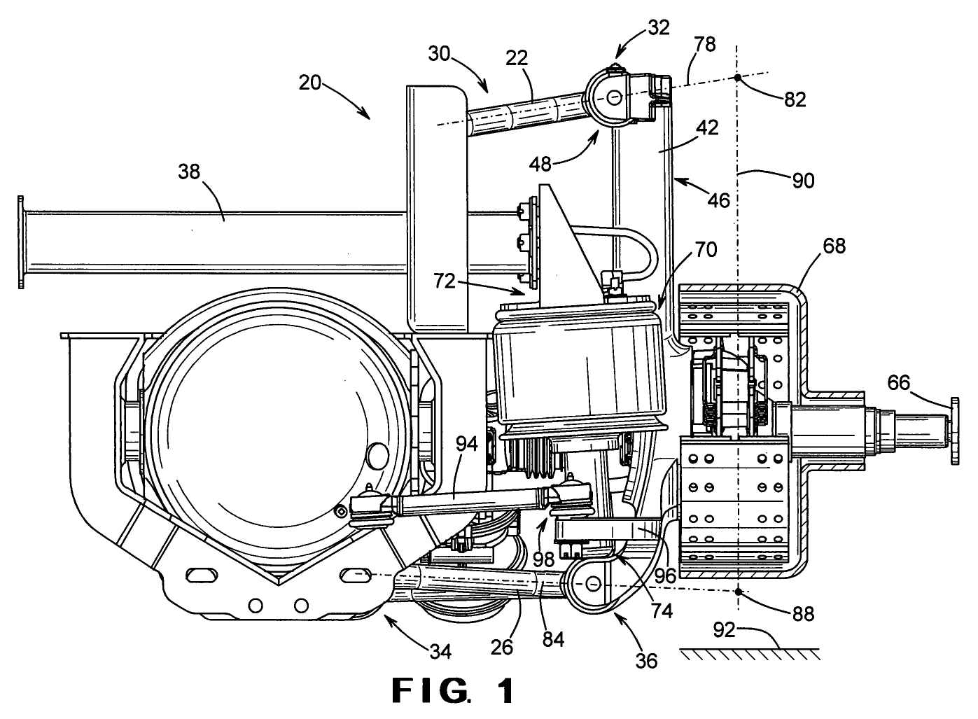

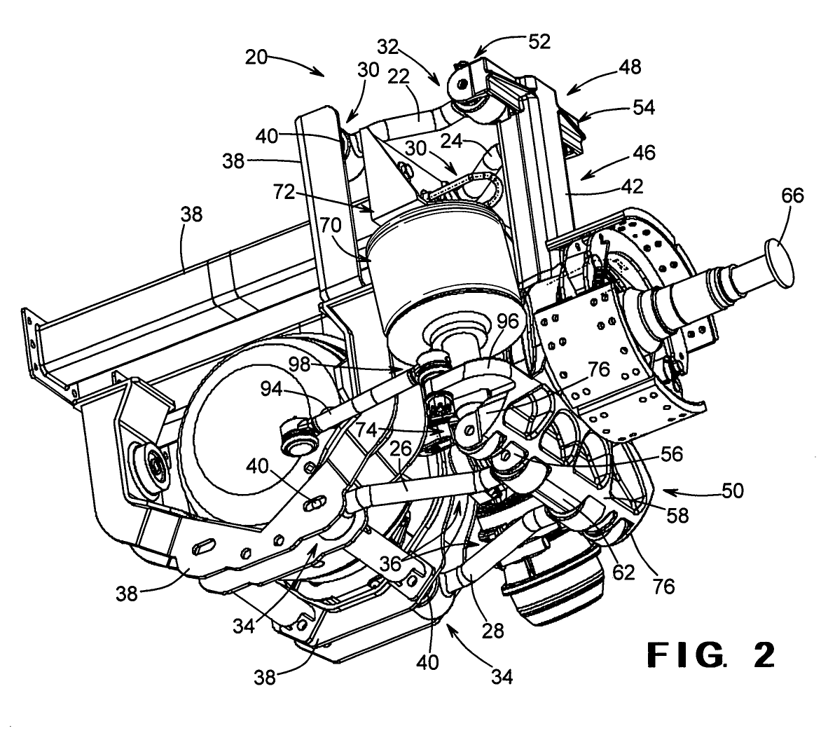

Referring now to FIGS. 1 and 2, an independent rear axle system 20 with steering capability for one side of a vehicle is depicted. The invention may also comprise an identical independent rear axle system with steering capability on the other side of the vehicle (not shown). Additionally, only side of one axle system is depicted. Those skilled in the art will appreciate that the present invention can be applied to more than one axle on a vehicle.

The components depicted in the figures are arranged for a vehicle with the engine in the rear. Those skilled in the art will appreciate that the present invention is equally adapted to a vehicle with the engine in the front. In a vehicle with the engine in the front, the steer arm, described in more detail below, will be connected to the opposite side of the knuckle, also described in more detail below, from the position shown in the figures.

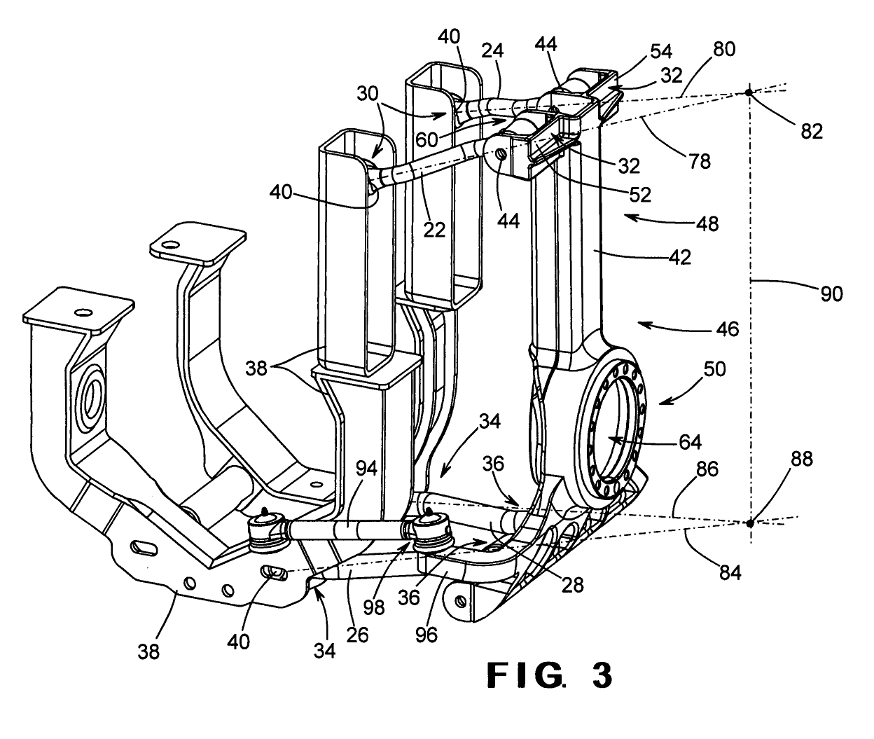

As best seen in FIG. 3, the system comprises a first upper link 22, a second upper link 24, a first lower link 26 and a second lower link 28. The first upper link 22 and the second upper link 24 each have inboard ends 30 and outboard ends 32. Similarly, the first lower link 26 and the second lower link 28 each have inboard ends 34 and outboard ends 36. As shown in FIGS. 2-3, the inboard ends 30 of both the upper links 22, 24 and the inboard ends 34 of both the lower links 26, 28 are attached to a vehicle chassis 38. Preferably, each inboard end 30, 34 of the upper and lower links 22, 24, 26, 28 is attached to the chassis 38 with a bushing 40 capable of rotational and conical motion. Other mechanical equivalents known to those skilled in the art can also be used to attach the inboard ends 30, 34 of the upper and lower links 22, 24, 26, 28 to the chassis 38.

The outboard ends 32, 36 of both of the upper links 22, 24 and the outboard ends 32, 36 of both of the lower links 26, 28 are attached to a knuckle 42. Preferably, each outboard end 32, 36 of the upper and lower links 22, 24, 26, 28 is attached to the knuckle 42 with a joint capable of rotational and conical motion. The joint may be such as a bushing 44, or a ball joint, as known to those skilled in the art. Other mechanical equivalents known to those skilled in the art can also be used to attach the outboard ends 32, 36 of the upper and lower links 22, 24, 26, 28 to the knuckle 42.

As depicted in FIG. 3, the upper and lower links 22, 24, 26, 28 have an S-shaped design. It is well within the scope of the present invention for the upper and/or lower links 22, 24, 26, 28 to also be substantially straight. It should be appreciated that the present invention is not limited to S-shapes for the links or straight links and that other link designs are within the scope of this invention.

As shown in FIG. 3, the knuckle 42 is not a standard steer knuckle with a kingpin. Preferably, the knuckle 42 has a central body portion 46 that supports an upper portion 48 and a lower portion 50. The outboard end 32 of one upper link 22 or 24 is attached to a first link attachment portion 52 on the upper portion 48 and the outboard end 32 of the other upper link 22 or 24 is attached to a second link attachment portion 54 on the upper portion 48. As best seen in FIG. 2, the outboard end 36 of one lower link 26 or 28 is attached to a first link attachment portion 56 on the lower portion 50 and the outboard end 36 of the other lower link 26 or 28 is attached to a second link attachment portion 58 on the lower portion 50.

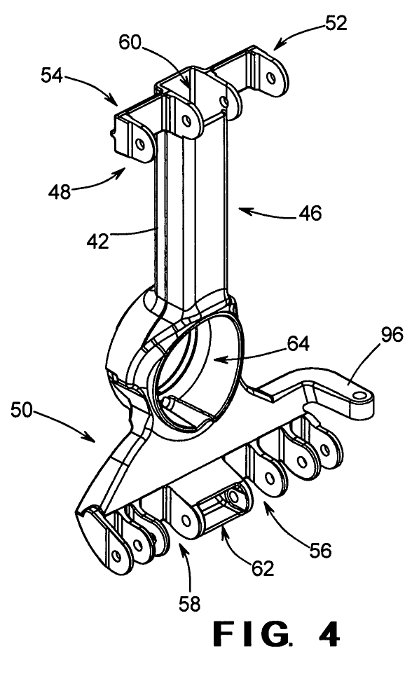

The knuckle 42, by itself, is depicted in FIG. 4. Looking at FIG. 4, it can be seen that the first and second link attachment portions 52, 54 on the upper portion 48 of the knuckle 42 are laterally separated from one another by a gap 60. Despite being laterally separated from one another by the gap 60, the first and second link attachment portions 52, 54 are preferably vertically aligned with one another. Similarly, the first and second link attachment portions 56, 58 of the lower portion 50 of the knuckle 42 are laterally separated from one another by a gap 62. Despite being laterally separated from one another by the gap 62, the first and second link attachment portions 56, 58 are preferably vertically aligned with one another.

Referring to FIGS. 1-4, an aperture 64 is provided through the knuckle 42 to accept a drive shaft 66. As discussed in more detail below, the present invention can be used with driven and non-driven axle systems. As shown only in FIG. 1, one or more wheels 68 are mounted to the drive shaft 66 in a manner well known to those skilled in the art.

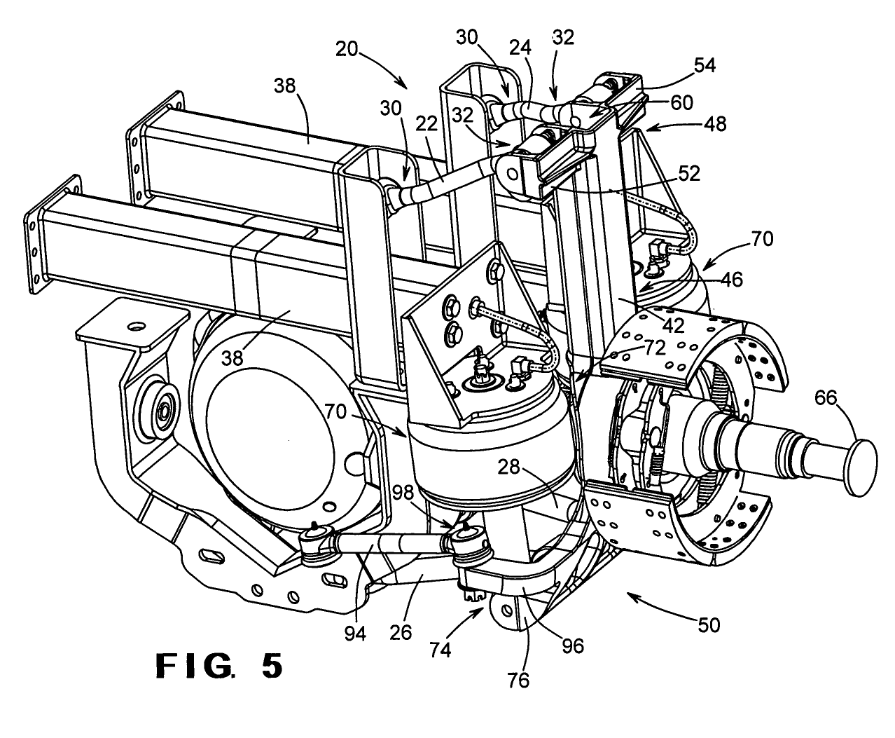

One or more suspension members may be attached to the chassis 38 and the knuckle 42. Referring to FIGS. 1 and 2, a combined air spring and shock absorber 70 having one end 72 attached to the chassis 38 and the other end 74 attached to a suspension mount 76 of the knuckle 42 is shown. Preferably, the suspension mount 76 is located on the lower portion 50 of the knuckle 42. As shown in FIGS. 2 and 5, it is preferred that two combined air springs and shock absorbers 70 are separately attached to the chassis 38 and are located on two separate suspension mounts 76 of the knuckle 42. The combined air springs and shock absorbers 70 are preferably mounted outboard on the knuckle 42 from the first and second link attachment portions 56, 58 on the lower portion 50 of the knuckle 42.

The upper links 22, 24 are attached to the chassis 38 and the knuckle 42, as described above, so that their respective axis 78, 80 intersect at a point 82, as shown in FIG. 3. Similarly, the lower links 26, 28 are attached to the chassis 38 and the knuckle 42, also as described above, so that their respective axis 84, 86 intersect at a point 88. Preferably, the intersection point 82 of the axis 78, 80 for the upper links 22, 24 and the intersection point 88 for the axis 84, 86 of the lower links 26, 28 are respectively located outboard from the knuckle 42.

A virtual steering axis 90 is located through the intersection point 82 of the axis 78, 80 of the upper links 22, 24 and the intersection point 88 of the axis 84, 86 of the lower links 26, 28, as shown in FIGS. 1 and 3. Preferably, the steering axis 90 is located at or near the center of the wheel 68 to minimize the turn scrub radius. As known by those skilled in the art, the scrub radius is the distance between the extended centerline of the steering axis and the centerline of the tire where the tread contacts the road.

It is also preferred that the steering axis 90 is oriented vertically with respect to the road 92 to minimize steer efforts, however, the axis 90 may be inclined slightly inboard or outboard to provide a virtual king pin angle and/or inclined slightly fore or aft to provide a virtual caster angle. Inclining the steering axis 90 in any of the four above-described directions may improve the ability of the system to return to a neutral steer position. It should be noted that inclination of the steer axis 90, however, may result in increased steer efforts.

As depicted in FIGS. 1, 2, 3 and 5, a steer link 94 is also attached to the knuckle 42. Preferably, the steer link 94 is pivotally attached to a steer link flange 96 of the lower portion 50 of the knuckle 42. In the preferred embodiment, the steer link 94 is attached to the knuckle 42 with a ball joint-type connection 98. The ball joint-type connection 98 is desirable since it permits precise control of the steer angle, as known by those skilled in the art. It is well within the scope of the present invention to attach the steer link 94 anywhere on the knuckle 42 with any type of connection.

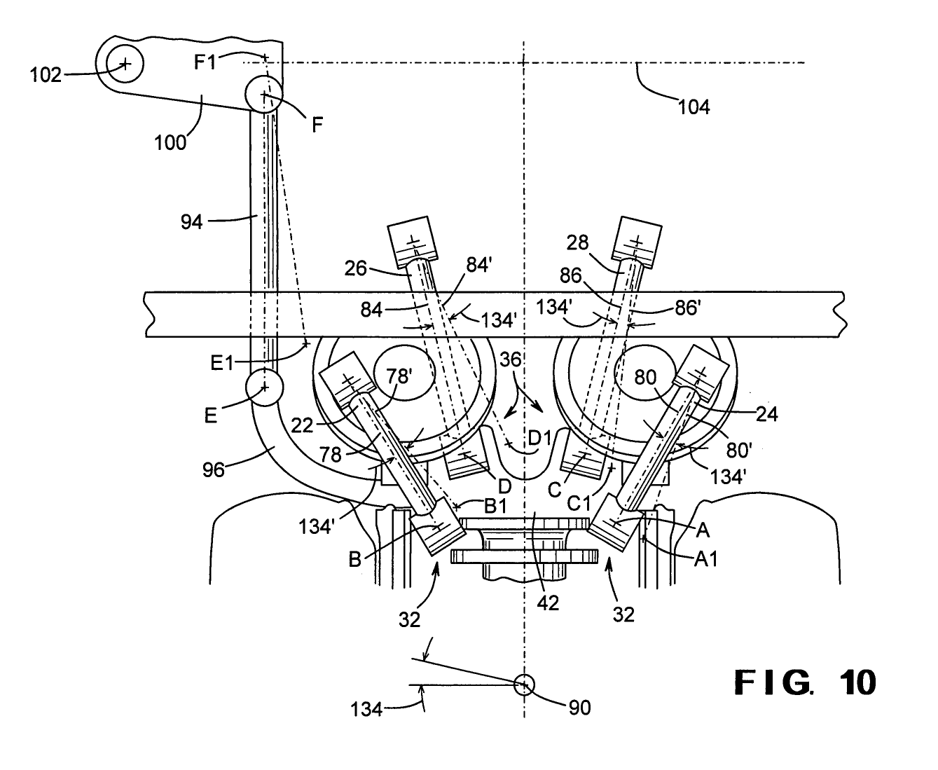

In a preferred embodiment as shown in FIG. 10, the steer link 94 is attached to a pitman arm 100. The pitman arm 100 rotates about a vertical axis 102 where the axis 102 is positioned at or near the chassis longitudinal center 104. The pitman arm 100 may be rotated by a mechanical linkage system connected to the steering system of the vehicle and/or it may be rotated by an electromechanical system selectively engaged by the vehicle operator or automatically engaged.

Those skilled in the art will appreciate that means other than the pitman arm 100 described above can be used to rotate the knuckle 42. For example, a rack and pinion system, one or more fluid driven cylinders, such as pneumatic or hydraulic cylinders, and/or a linear gear may be used without departing from the scope of the present invention.

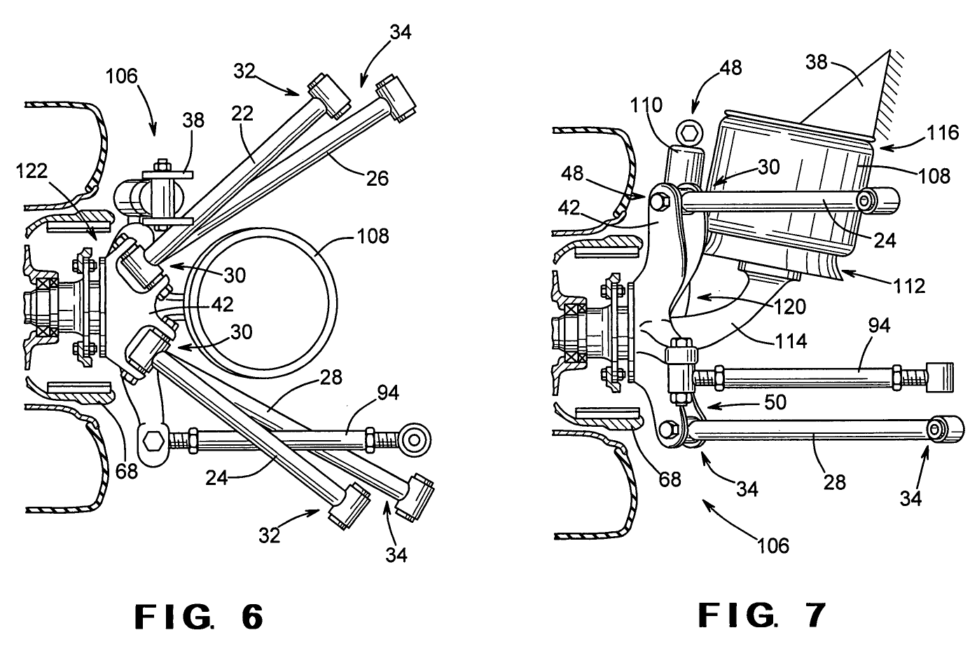

Two alternative embodiments to the invention described above are depicted in FIGS. 6-9 wherein a non-driven independent, steerable, rear axle system 106 is shown. The non-driven axle system 106 has all of the attributes of the driven axle system 20, including the steer link 94 pivotally attached to the knuckle 42, except at least the modifications described below have been made. Therefore, like reference numbers from FIGS. 1-5 will be used for like components depicted in FIGS. 6-9. Although FIGS. 6-9 depict substantially straight upper and lower links 22, 24, 26, 28, it must be appreciated that the S-shaped upper and lower links described above may also be used. Straight links may require the links to be mounted at angles with respect to the knuckle rather than inboard ends that are substantially perpendicular to the knuckle.

FIGS. 6 and 7 depict a separate air spring 108 and shock 110 for the non-driven axle system 106. This embodiment of the system 106 only uses one air spring 108 and one shock 110 on one side of each axle. One end 112 of the air spring 108 is supported, in part, by an air spring mount 114 attached to the knuckle 42. The air spring mount 114 may be integrally cast with the knuckle 42 or it may be bolted directly thereto. The other end 116 of the air spring 108 is attached to the chassis 38 by means known to those skilled in the art. Preferably, the air spring 108 is provided with sufficient ability to deflect as the knuckle 42 rotates during steering motions.

The air spring 108 is preferably located inboard of the knuckle 42, aft of the first upper link 22 and the first lower link 26 and fore of the second upper link 24 and the second lower link 28. One end 118 of the shock 110 is preferably mounted for rotational and conical motion with respect to the chassis 38. The other end 120 of the shock 110 is preferably mounted to the knuckle 42 with a spherical bearing, or bushing (not shown), to accommodate the rotational and conical motion of the knuckle 42. Other mechanical equivalents to the above-described mountings for the air spring 108 and shock 110 to both the chassis 38 and the knuckle 42 are well within the scope of the present invention. As best seen in FIG. 6, the shock 110 is preferably mounted on a forward portion 122 of the knuckle 42.

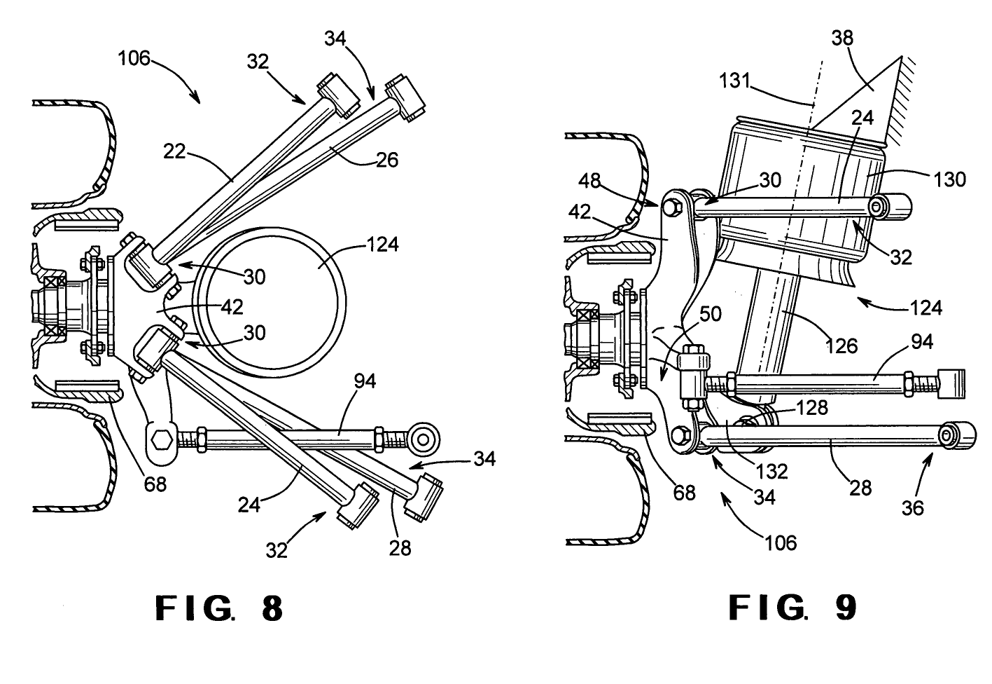

FIGS. 8 and 9 depict another embodiment of the non-driven axle system 106. In this embodiment, the shock and air spring are combined into a suspension unit 124. This embodiment of the system 106 only uses one suspension unit 124 on one side of each axle. The shock portion 126 of the suspension unit 124 is mounted to the knuckle 42, preferably with a spherical bearing, or bushing 128, as known to those skilled in the art. The spherical bearing, or bushing 128, accommodates the rotational motion of the knuckle 42 during steering motions. The air spring portion 130 is supported on the shock portion 126 and attached to the chassis 38 in a manner known to those skilled in the art. Preferably, the air spring portion 130 and the shock portion 126 share a common axis 131.

A shock mount 132 of the knuckle 42, for mounting the shock portion thereto, may be integrally cast with the knuckle 42 or it may be bolted directly to the knuckle 42. The suspension unit 124 is preferably located inboard of the knuckle 42, aft of first upper link 22 and the first lower link 26 and fore of the second upper link 24 and the second lower link 28.

A method of steering the invention will describe the process referencing the driven axle system 20 depicted in FIGS. 1-5. Those skilled in the art will readily appreciate that the method is substantially identical for the non-driven system 106 described above and depicted in FIGS. 6-9.

FIGS. 1-3 described above depict the system 20 having a zero steer angle. A preferred method of changing the steer angle comprises rotating the pitman arm 100 by any of the means described above. In the preferred embodiment best seen in FIG. 10, the pitman arm 100 is rotated to translate the steer link 94 in an inboard direction. The upper and lower links 22, 24, 26 and 28 are schematically depicted in FIG. 10.

The translation of the steer link 94 is depicted in FIG. 10 wherein positions E and F are the non-steer positions of a first and a second end of the steer link 94. During a steering action, the first and second ends of the steer link 94 translate to positions E1 and F1, respectively. Those skilled in the art will appreciate that based upon the input from the pitman arm 100, steer link 94 positions E1 and F1 can be located any distance from positions E and F.

Movement of the steer link 94 to an inboard direction urges the knuckle 42 to rotate proportionally to the rotational movement of the pitman arm 100.

The inboard ends 30, 34 of the upper and lower links 22, 24, 26, 28 pivot about their bushings 40 in response to the rotation of the knuckle 42. The upper and lower outboard link ends 32, 36 attached to the knuckle 42 move from their non-steer positions, A-D, to steer positions, A1-D1, respectively, as depicted in FIG. 10. A steer angle 134 is created due to the kinematic motion of each of the upper and lower links 22, 24, 26, 28 in the horizontal plane. Preferably, the knuckle 42 pivots about the virtual steer axis 90 defined by the intersection points 82, 88 of the axis 78, 80, 84, 86 extended from the upper and the lower links 22, 24, 26, 28. Those skilled in the art will appreciate that based upon the input from the pitman arm 100, steer positions A1-D1 can be displaced from non-steer positions A-D by any amount.

In the preferred embodiment, the angles 134′ between the axis 78, 80, 84, 86 of the upper and lower links 22, 24, 26, 28 in the non-steer position and the axis 78′, 80′, 84′, 86′ of the upper and lower links 22, 24, 26, 28 in the steer position relative to the chassis 38 are about the same as the steer angle 134. Additionally, the angle of the outboard ends of the upper and lower links relative to the knuckle is approximately double the steer angle 134.

In accordance with the provisions of the patent statutes, the present invention has been described in what is considered to represent its preferred embodiments. However, it should be noted that the invention can be practiced otherwise than as specifically illustrated and described without departing from its spirit or scope.

1. An axle system having steering capability, comprising:
a first upper link defining an axis and having an outboard end rotatably mounted to a knuckle and an inboard end rotatably mounted to a vehicle chassis;
a second upper link defining an axis and having an outboard end rotatably mounted to said knuckle and an inboard end rotatably mounted to said vehicle chassis;
a first lower link defining an axis and having an outboard end rotatably mounted to said knuckle and an inboard end rotatably mounted to said vehicle chassis;
a second lower link defining an axis and having an outboard end rotatably mounted to said knuckle and an inboard end rotatably mounted to said vehicle chassis; and
a steer link having one end connected to a selectively moveable steer mechanism and the other end pivotally connected directly to a steer link flange on a lower portion of said knuckle;
wherein said axis of said first upper link and said axis of said second upper link intersect at an upper point outboard of said knuckle and said axis of said first lower link and said axis of said second lower link intersect at a lower point outboard of said knuckle, and wherein a line through said upper point and said lower point forms a steer axis about which said knuckle rotates.

2. The system of claim 1, wherein said first upper link, said first lower link, said second upper link, said second lower link, said steer link and said knuckle comprise one side of a rear, steerable axle system of a vehicle.

3. The system of claim 1, wherein said inboard ends of said upper links and said lower links are mounted for both rotational and conical motion to said vehicle chassis with bushings.

4. The system of claim 1, wherein said outboard ends of said upper links and said lower links are mounted for both rotational and conical motion to said knuckle with bushings.

5. The system of claim 1, wherein a drive shaft aperture is located through said knuckle.

6. The system of claim 1, wherein said steer axis extends substantially through the center of a wheel.

7. The system of claim 1, wherein said steer axis is substantially orthogonal with respect to the ground.

8. The system of claim 1, wherein said knuckle has an upper portion and said first upper link is connected to a first upper link attachment portion on said upper portion and said second upper link is connected to a second upper link attachment portion on said upper portion.

9. The system of claim 8, wherein said first lower link is connected to a first lower link attachment portion on said lower portion of said knuckle and said second lower link is connected to a second lower link attachment portion on said lower portion of said knuckle.

10. The system of claim 9, wherein two combined air spring and shocks are attached at one end to said vehicle chassis and the other end of said combined air spring and shocks are directly attached for both pivotal and conical motion to said lower portion of said knuckle.

11. The system of claim 10, wherein said combined air spring and shocks are attached to two separate suspension mounts on said lower portion of said knuckle, said suspension mounts being located outboard of said first lower link attachment portion and said second lower link attachment portion.

12. An axle system having steering capability, comprising:
a first upper link defining an axis and having an outboard end rotatably mounted to a knuckle and an inboard end rotatably mounted to a vehicle chassis;
a second upper link defining an axis and having an outboard end rotatably mounted to said knuckle and an inboard end rotatably mounted to said vehicle chassis;
a first lower link defining an axis and having an outboard end rotatably mounted to said knuckle and an inboard end rotatably mounted to said vehicle chassis;
a second lower link defining an axis and having an outboard end rotatably mounted to said knuckle and an inboard end rotatably mounted to said vehicle chassis;
a single air spring connected to an air spring mount connected to said knuckle, said air spring mount extending inwardly toward said chassis from said knuckle; and
a single shock absorber, separate from said air spring, attached for rotation with respect to said knuckle;
wherein said axis of said first upper link and said axis of said second upper link intersect at an upper point outboard of said knuckle and said axis of said first lower link and said axis of said second lower link intersect at a lower point outboard of said knuckle, and wherein a line through said upper point and said lower point forms a steer axis about which said knuckle rotates.

13. The system of claim 12, wherein said knuckle has an upper portion and said first upper link is connected to a first upper link attachment portion on said upper portion and said second upper link is connected to a second upper link attachment portion on said upper portion and said knuckle has a lower portion and said first lower link is connected to a first lower link attachment portion on said lower portion and said second lower link is connected to a second lower link attachment portion on said lower portion.

14. The system of claim 12, wherein said air spring is located aft of said first upper link and said first lower link and fore of said second upper link and said second lower link.

15. The system of claim 12, wherein said shock absorber is attached to said knuckle forward of said first upper link and said first lower link.

16. The system of claim 12, further comprising a steer link having one end connected to a selectively moveable steer mechanism and the other end pivotally connected directly to a steer flange on a lower portion of said knuckle.

17. An axle system having steering capability, comprising:
a first upper link defining an axis and having an outboard end rotatably mounted to a knuckle and an inboard end rotatably mounted to a vehicle chassis;
a second upper link defining an axis and having an outboard end rotatably mounted to said knuckle and an inboard end rotatably mounted to said vehicle chassis;
a first lower link defining an axis and having an outboard end rotatably mounted to said knuckle and an inboard end rotatably mounted to said vehicle chassis;
a second lower link defining an axis and having an outboard end rotatably mounted to said knuckle and an inboard end rotatably mounted to said vehicle chassis;
a single combined shock absorber and air spring sharing a common axis, said shock absorber mounted for rotation to an inwardly extending mount of said knuckle;
wherein said axis of said first upper link and said axis of said second upper link intersect at an upper point outboard of said knuckle and said axis of said first lower link and said axis of said second lower link intersect at a lower point outboard of said knuckle, and wherein a line through said upper point and said lower point forms an axis about which said knuckle rotates.

18. The system of claim 17, wherein said combined air spring and shock absorber is located aft of said first upper link and said first lower link and forward of said second upper link and said second lower link.

19. The system of claim 17, further comprising a steer link having one end connected to a selectively moveable steer mechanism and the other end pivotally connected directly to a steer link flange on a lower portion of said knuckle.

20. A steerable knuckle for a vehicle, comprising:
an upper portion having two laterally separated but vertically aligned upper link attachment portions;
a lower portion having two laterally separated but vertically aligned lower link attachment portions, said lower portion also having two suspension member attachment portions separated by said lower link attachment portions, said lower portion also having a steering flange; and
a central portion connecting said upper portion and said lower portion and having an aperture therethrough for a drive shaft.
